(19) United States
(12) Patent Application Publication
(10) Pub. No.: US 2011/0145183 A1
(43) Pub. Date: Jun. 16, 2011

(54) PREDICTOR OF THE PERIOD OF PSYCHOTIC EPISODE IN INDIVIDUAL SCHIZOPHRENICS AND ITS METHOD

(76) Inventors: Tsuo-Hung LAN, Taichung County (TW); El-Wui Loh, Taipei County (TW); Hesien-Chang Chiu, Tainan County (TW); Chun-Jung Huang, Nantou County (TW)

(21) Appl. No.: 12/712,702

(22) Filed: Feb. 25, 2010

(30) Foreign Application Priority Data
Dec. 11, 2009 (TW) 098142398

(51) Int. Cl. G06N 5/02; G06F 17/10

(52) U.S. Cl. 706/46; 703/2

(57) ABSTRACT

A predictor of the period of psychotic episode in individual schizophrenia patients, and its method. It consists of, a data constructor and an incident simulator, which concludes rules from the total incidents of patients' recurrence as well as the historical time data. Then it applies the said rules to predict the following happening time of a recurrence or a stabled situation.

### FIELD OF THE INVENTION

The present invention is directed to a predictor of the period of psychotic episode in individual schizophrenia patients, which concludes rules from the total incidents of patients' recurrence as well as the historical time data, then applies the rules to predict the following happening time of a recurrence or a stabled situation.

### BACKGROUND OF THE INVENTION

Schizophrenia is a most common psychiatric illness. After the first onset, patients will be subject to subsequently indeterminate recurrence and suffering a cyclical processes of steady-recurrent-steady stages. In the light of schizophrenia may results from multiple factors for example heredity, growth environment, neurotransmitter overactive and the likes; the causes of diseases are still not fully understood thus far, therefore, many investigators focus their studies especially on gender, age of first onset, birthplace, birth season etc. of the first onset patients, those are parameters can be collected and quantized easily. Although study on related variables of first onset patients is conducive to understand partial factors of schizophrenia, but it is not only a chronic but also a medical refractory diseases, additionally, side effect of patient's mental regression often cause by medical treatment, hereby how to conduct subsequent medical attention still an important issue.

Generally, psychotic medical attention of National Health Insurance provides active treatment and rehabilitation therapy two kinds of ward. Patients will be assigned to former if recurrence, where they through a process of bed registry, physical examination, family visiting etc. to obtain medicine, injection and psychotherapy for regain steady condition gradually. Since the disease will constant aggravation every time when relapse, therefore it often coping with increases dosage or changes drug as a corresponding strategies. Usually, patients will recovery to a steady state after one to three months of active treatment and can proceed effective communication with others, in this case, patients can be transfer to community care unit (such as recovery home, day care hospital etc.) for subsequent rehabilitation and to psychiatric clinic for medical follow-up periodically. However, when patients unable return home or discharge from hospital according to schedule because of self-care disability or unable to provide home care result from long-term psychosis, the patients will be transfer to rehabilitation therapy ward and accept a variety of rehabilitation program according to the level of regression after receive various assessments (psychiatric inventory test, nursing activity, rehabilitation achievements etc.); patients will be re-enter active treatment ward when relapse. Give favorable and suitable medical attention based on disease condition by judging disease diagnosis rating scales and particular endpoints periodically, hereby patient's condition will be controlled under a certain steady state.

In view of labile psychotropic status in schizophrenia recurrence patients, the patients will predispose himself in self-harm or severely interfere and hurt others; it will results incredible losses of social cost if misjudgment or delay treatment. Therefore, it is desirable to predict the period of psychotic episode of a patient in the field of medical science.

Since labile psychotropic status in schizophrenia recurrence patients, the patients will predispose himself in self-harm or severely interfere and hurt others, it will results incredible losses of social cost. It is thus an object of the present invention to provide a real-time disease evaluation system, it can help medical personnel to pre-diagnosis diseases and decrease lead time of diagnosis, moreover, it can perform accurate follow-up diagnosis periodically.

### SUMMARY OF THE INVENTION

To achieve foregoing objective, the present invention disclose a predictor of the period of psychotic episode in individual schizophrenics, at least comprise:

a data constructor, which input many time points of experienced relapse or steady state information, and analyze regularity of said historical time data;

an incident simulator, which receive analyzed regularity of said data constructor, and predict time point of next relapse or steady state.

For the purpose of preceding objective, the present invention disclose a method to predict relapse time of schizophrenia patients, it make use of historical time points of total incidents of patients' recurrence and steady state to find its regularity, and estimate time point of next relapse or steady state.

These and other features of the present invention will become more apparent from the following detailed description of embodiment when taken in conjunction with the accompanying drawings.

### BRIEF DESCRIPTION OF THE FIGURES

FIG. 1 shows a circuit schematic diagram of the present invention;

FIG. 2 shows a flow diagram of a data constructor's data construct steps of the present invention;

FIG. 3 shows a flow diagram of an incident simulator's process analysis steps of the present invention.

### DETAILED DESCRIPTION OF THE INVENTION

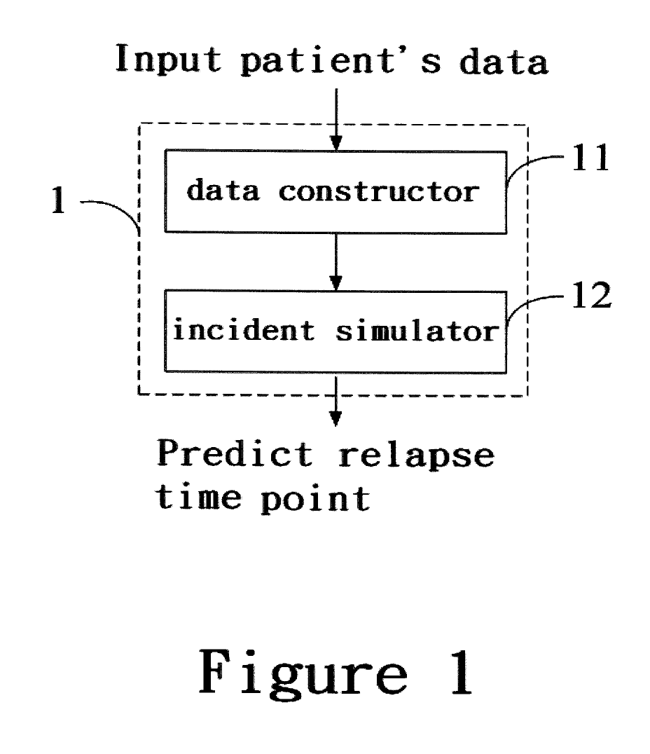

Please refer to FIG. 1, it is a circuit schematic diagram of the present invention. A predictor of the period of psychotic episode in individual schizophrenics, at least comprise: a data constructor 11 and an incident simulator 12. It make use of historical time points of total incidents of patients' recurrence and steady state to find its regularity, and estimate time point of next relapse or steady state.

Let assign I as relapse and T as stability, then record experienced relapse time as IRT and experienced time of steady state as TRT. Assume a patient's historical data of relapse are I={i1, i2, . . . , i5} and T={t1, t2, . . . , t4} with year/month/day format for each data; above mentioned data represent this patient have been relapsed five times and still undergoing relapse status. Let ΔI represents experienced relapse time and ΔT represents experienced time of steady state with days as calculated time units; therefor, ΔI1=t1−i1 and ΔT1=i2−t1.

The utilization of patient's historical data, preceding data constructor and incident simulator can be breakdown into several steps as follow respectively.

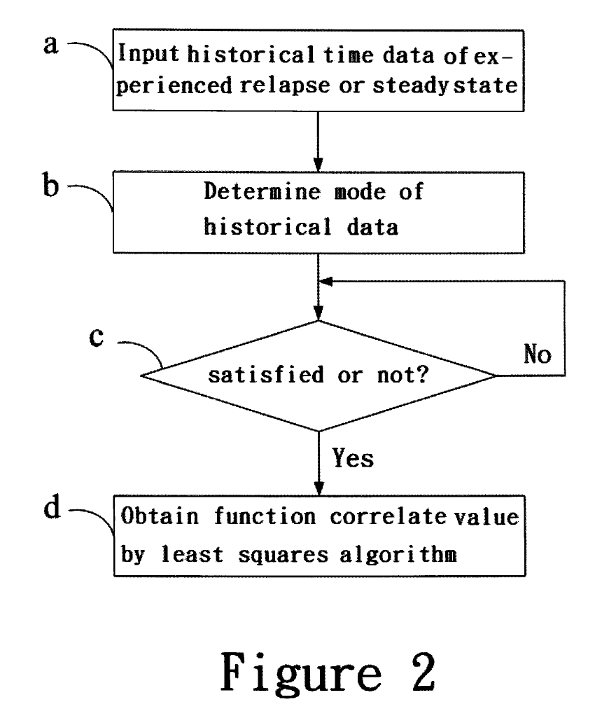

Please refer to FIG. 2, it shows data construct steps of a data constructor, said data construct steps at least comprise:
(a) input historical time data of experienced relapse or steady state information;
(b) determine mode of historical data;
(c) judge whether preceding data are satisfied or not, proceed to next step if satisfied or repeat said step if not satisfied;
(d) obtain function correlate value (fΔI and fΔT) of relapse and steady state versus possibility of occurrence by least squares algorithm.

Aforementioned data construct step(a) at least comprises the following steps:

(a1) set k>1 and t=1;

(a2) set

Aₒ={(aᵢ_{ₒ},λᵢ)|aᵢ_{ₒ}δ□,λᵢε□, a₍ᵢ₊₁₎_{ₒ}>aᵢ_{ₒ}, a₍ᵢ₊₁₎_{ₒ}>aᵢ_{ₒ}, 1≦i,iₒ≦n},

where aᵢ_{ₒ} is time numerical value, λᵢ is corresponding individual value. And assume C={(1, 1), (c, 1)}, where c>1.

Aforementioned data construct step(b) at least comprises the following steps:

(b1) determine mode of historical data (mode(Ao)) according to equation (1), where Pctl[.] is percentile.

$$\{ \begin{matrix}steady \text{:} mode ( {A}_{o} ) = \{ \begin{matrix}{max}_{{λ}_{i}} \{ ( {α}_{{i}_{o}} , {λ}_{i} ) \} , if only one mode \\ Pct 1 [ \frac{patient age}{67} ] , if several modes\end{matrix} \\ relapse \text{:} mode ( {A}_{o} ) = \{ \begin{matrix}{max}_{{λ}_{i}} \{ ( {α}_{{i}_{o}} , {λ}_{i} ) \} , if only one mode \\ Pct 1 [ 1 - \frac{patient age}{67} ] , if several modes\end{matrix} ;\end{matrix} \qquad ( 1 )$$

(b2) select modes and shift the value of historical data as:

A={(ai,λi)|aiε□,λᵢε□,1≦i≦n}, where ai=aᵢ_{ₒ}−mode(Ao).

Aforementioned data construct step(c) at least comprises the following steps:

(c1)

Z^{t}≡A(:)C^{t}={(z_{q}_{^{t}},f_{q}_{^{t}})|z_{q}_{^{t}}ε[a₁,aₙ],f_{q}_{^{t}}ε□,1≦q≦Q}, Q≦2^{t}*|A|, ∀tε□;

(c2) set parameter w, where

w≧1−((|Z^{t}|+1)(k²+|Z^{t}|−1))⁻¹(|Z^{t}|k²),

x̅^{t}=((Σ_{q}z_{q}_{^{t}}*f_{q}_{^{t}})/|Z^{t}|),

s^{t}=((|Z^{t}|⁻¹Σ_{q}z_{q}_{^{t}}²*f_{q}_{^{t}})−( x̅^{t})²)^{0.5}, if satisfied P(|z_{q}_{^{t}}− x̅^{t}|≦ks^{t})≧w, then proceed to next step(d); or back to (c1) if not satisfied the preceding condition.

Aforementioned data construct step(d) at least comprises the following steps:

(d1) set t=T, calculate z′_{q}_{^{T}}=z_{q}_{^{T}}+mode(Aₒ), and output Z^{T′}={(z′_{q}_{^{T}}, f_{q}_{^{T}})};

(d2) set the distribution of Z^{T′} is divided into M peaks, where each peak can be represent as {zₘ(fₘ)|zₘεZ^{T′}, fₘε□, 1≧m≧M};

(d3) let H={(x1, y1), (x2, y2), . . . (xM+2, yM+2)}={(z′₁_{^{T}}, f₁_{^{T}}/Σₘ(fₘ+f₁_{^{T}}+f_{Q}_{^{T}})), {(zₘ, fₘ/Σₘ(fₘ+f₁_{^{T}}+f_{Q}_{^{T}}))|1≦m≦M}, (z′_{Q}_{^{T}}, f_{Q}_{^{T}}/Σₘ(fₘ+f₁_{^{T}}+f_{Q}_{^{T}}))};

(d4) if the distribution of H is an approximate quasi-concave, then calculate corresponding function correlation of each point of {(x1,log(y1)), (x2, log(y2)), . . . , (xM+2, log(yM+2))} by least squares algorithm; if H distribution is not an approximate quasi-concave, then calculate corresponding function correlation of each point of {(x1, y1), (x2, y2), . . . , (xM+2, yM+2)} by least squares algorithm. In this step, a function which shows the regularity of relapse or steady state time will be obtained; where fΔI and fΔT represent function correlation of relapse and steady state versus possibility of occurrence respectively.

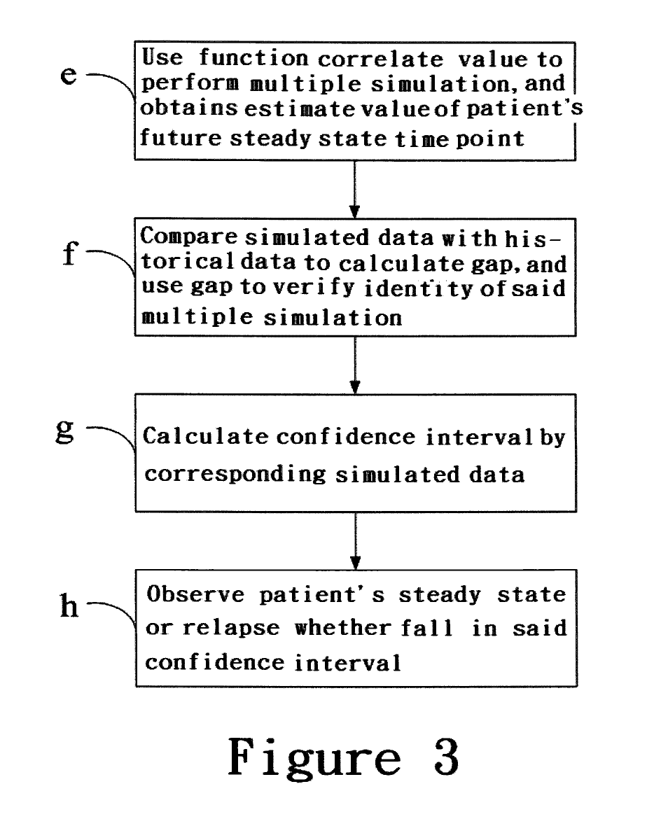

Please refer to FIG. 3, it is process analysis steps of incident simulator 12, the process analysis steps at least comprise:

(e) receive data from data constructor to obtain function correlate value (fΔI and fΔ), and use said function correlate value (fΔI and fΔ) to perform multiple simulation, the estimate value of patient's future steady state time point will be obtained by said simulation;

(f) compare simulated data with historical data to calculate its gap, and use said gap to verify identity of said multiple simulation;

(g) calculate confidence interval of patient's future steady state time point by corresponding simulated data;

(h) observe patient's steady state or relapse whether fall in said confidence interval.

Above-mentioned process analysis step(e) expresses its recorded multiple simulation data as equation E={î₁, \hat{t}₁, î₂, \hat{t}₂, î₃, \hat{t}₃, î₄, \hat{t}₄, î₅, \hat{t}₅}; wherein \hat{t}₅ is our estimate value of patient's future steady state time point.

Above-mentioned process analysis step(f) at least comprises the following steps:

(f1) Let gap be express as e (at unit of day), record simulated data if it meet equation

$$( {\sum }_{r = 1}^{5} \vert {\hat{i}}_{r} - {i}_{r} \vert + {\sum }_{r = 1}^{4} \vert {\hat{t}}_{r} - {t}_{r} \vert ) / 9 ≦ e ;$$

(f2) assume there are J coincidence simulated data, then for each recoded data will be express by equation as Ej={î₁^{j}, \hat{t}₁^{j}, î₂^{j}, \hat{t}₂^{j}, î₃^{j}, \hat{t}₃^{j}, î₄^{j}, \hat{t}₄^{j}, î₅^{j}, \hat{t}₅^{j}}, j=1, 2, . . . , J.

In above-mentioned process analysis step(g), a predicted upcoming confidence interval of steady state time point will be calculated by step(f2) of {\hat{t}₅¹, \hat{t}₅², . . . , \hat{t}₅^{J}} in J simulated data. If adopt 95% or 99% as a common confidence level, then said confidence interval can be expressed by equation as

$$( \overline{\hat{t}} - {Z}_{α / 2} * \frac{{s}_{{\hat{t}}_{5}}}{\sqrt{J}} , \overline{\hat{t}} + {Z}_{α / 2} * \frac{{s}_{{\hat{t}}_{5}}}{\sqrt{J}} ) .$$

Above-mentioned process analysis step(h) at least comprises the following steps:

(h1) observe patient's steady state or relapse whether its occurrence is fall in said confidence interval; if yes, then said confidence interval be regarded as a successful prediction;

(h2) incorporate this t5 value of steady state time point into historical data, repeat said data construct for calculate new fΔI and fΔT in order to predict emersion time of next steady state time point i6.

The foregoing preferred embodiments of the present invention are disclosed above, however they are not a limitation of the scope of the present invention in any way, and it will be apparent to those skilled in the art that various changes and modifications can be made without departing from the invention, therefore, will be protected by the scope of the appended claims.

1. A predictor of the period of psychotic episode in individual schizophrenics, at least comprise:
a data constructor, which input many time points of experienced relapse or steady state information, and analyze regularity of said historical time data;
an incident simulator, which receive analyzed regularity of said data constructor, and predict time point of next relapse or steady state.

2. The predictor of the period of psychotic episode in individual schizophrenia patients of claim 1, wherein the data construct steps of said data constructor at least comprise:
(a) input historical time data of experienced relapse or steady state information;
(b) determine mode of historical data;
(c) judge whether preceding data are satisfied or not, proceed to next step if satisfied or repeat said step if not satisfied;
(d) obtain function correlate value (fΔI and fΔT) of relapse and steady state versus possibility of occurrence by least squares algorithm.

3. The predictor of the period of psychotic episode in individual schizophrenia patients of claim 2, wherein said step(a) at least comprises the following steps:
(a1) set k>1 and t=1;
(a2) set
Aₒ={(aᵢ_{ₒ},λᵢ)|aᵢ_{ₒ}ε□,λᵢε□,a₍ᵢ₊₁₎_{ₒ}>aᵢ_{ₒ}, 1≦i,iₒ≦n},
and assume C={(1, 1), (c, 1)}, where c>1.

4. The predictor of the period of psychotic episode in individual schizophrenia patients of claim 2, wherein said step(b) at least comprises the following steps:
(b1) determine mode of historical data (mode(Ao)) according to equation (1):
$$\{ \begin{matrix}steady \text{:} mode ( {A}_{o} ) = \{ \begin{matrix}{max}_{{λ}_{i}} \{ ( {α}_{{i}_{o}} , {λ}_{i} ) \} , if only one mode \\ Pct 1 [ \frac{patient age}{67} ] , if several modes\end{matrix} \\ relapse \text{:} mode ( {A}_{o} ) = \{ \begin{matrix}{max}_{{λ}_{i}} \{ ( {α}_{{i}_{o}} , {λ}_{i} ) \} , if only one mode \\ Pct 1 [ 1 - \frac{patient age}{67} ] , if several modes\end{matrix} ;\end{matrix} \qquad ( 1 )$$
(b2) select modes and shift the value of historical data as:
A={(ai,λᵢ)|aiε□,λᵢε□, 1≦i≦n}, where ai=aᵢ_{ₒ}−mode(Ao).

5. The predictor of the period of psychotic episode in individual schizophrenia patients of claim 2, wherein said step(c) at least comprises the following steps:
(c1)
Z^{t}≡A(:)C^{t}={(z_{q}_{^{t}},f_{q}_{^{t}})|z_{q}_{^{t}}ε[a₁,aₙ],f_{q}_{^{t}}ε□,1≦q≦Q},Q≦2^{t}*|A|,∀tε□;
(c2) set parameter w, where
w≦1−((|Z^{t}|+1)(k²+|Z^{t}|−1))⁻¹(|Z^{t}|k²),
x̅^{t}=((Σ_{q}z_{q}_{^{t}}*f_{q}_{^{t}})/|Z^{t}|),
s^{t}=((|Z^{t}|⁻¹Σ_{q}z_{q}_{^{t}}²*f_{q}_{^{t}})−( x̅^{t})²)^{0.5}, if satisfied P(|z_{q}_{^{t}}− x̅^{t}|≦ks^{t})≧w, then proceed to next step(d); or back to (c1) if not satisfied the preceding condition.

6. The predictor of the period of psychotic episode in individual schizophrenia patients of claim 2, wherein said step(d) at least comprises the following steps:
(d1) set t=T, calculate z_{q}_{^{T}}=z_{q}_{^{T}}+mode(Aₒ), and output Z^{T′}={(z′_{q}_{^{T}}, f_{q}_{^{T}})};
(d2) set the distribution of Z^{T′} is divided into M peaks, where each peak can be represent as {zₘ(fₘ)|zₘεZ^{T′}, fₘε□, 1≦m≦M};
(d3) let H={(x1, y1), (x2, y2), . . . (xM+2, yM+2)}={(z′₁_{^{T}}, f₁_{^{T}}/Σₘ(fₘ+f₁_{^{T}}+f_{Q}_{^{T}})), {(zₘ, fₘ/Σₘ(fₘ+f₁_{^{T}}+f_{Q}_{^{T}}))|1≦m≦M}, (z′_{Q}_{^{T}}, f_{Q}_{^{T}}/Σₘ(fₘ+f₁_{^{T}}+f_{Q}_{^{T}}))};
(d4) if the distribution of H is an approximate quasi-concave, then calculate corresponding function correlation of each point of {(x1,log(y1)), (x2, log(y2)), . . . , (xM+2, log(yM+2))} by least squares algorithm; if H distribution is not an approximate quasi-concave, then calculate corresponding function correlation of each point of {(x1, y1), (x2, y2), . . . , (xM+2, yM+2)} by least squares algorithm.

7. The predictor of the period of psychotic episode in individual schizophrenia patients of claim 1, wherein the process analysis steps of said incident simulator at least comprise:
(e) receive data from data constructor to obtain function correlate value, and use said function correlate value to perform multiple simulation, the estimate value of patient's future steady state time point will be obtained by said simulation;
(f) compare simulated data with historical data to calculate its gap, and use said gap to verify identity of said multiple simulation;
(g) calculate confidence interval of patient's future steady state time point by corresponding simulated data;
(h) observe patient's steady state or relapse whether fall in said confidence interval.

8. The predictor of the period of psychotic episode in individual schizophrenia patients of claim 7, wherein said step(e) expresses its recorded multiple simulation data as equation E={î₁, \hat{t}₁, î₂, \hat{t}₂, î₃, \hat{t}₃, î₄, \hat{t}₄, î₅, \hat{t}₅}.

9. The predictor of the period of psychotic episode in individual schizophrenia patients of claim 7, wherein said step(f) at least comprises the following steps:
(f1) Let gap be express as e (at unit of day), record simulated data if it meet equation
$$( {\sum }_{r = 1}^{5} \vert {\hat{i}}_{r} - {i}_{r} \vert + {\sum }_{r = 1}^{4} \vert {\hat{t}}_{r} - {t}_{r} \vert ) / 9 ≦ e ;$$
(f2) assume there are J coincidence simulated data, then for each recoded data will be express by equation as Ej={î₁^{j}, \hat{t}₁^{j}, î₂^{j}, \hat{t}₁^{j}, î₃^{j}, \hat{t}₃^{j}, î₄^{j}, \hat{t}₄^{j}, î₅^{j}, \hat{t}₅^{j}}, j=1, 2, . . . , J.

10. The predictor of the period of psychotic episode in individual schizophrenia patients of claim 7, wherein said confidence interval of step(g) can be expressed by equation as
$$( \overline{\hat{t}} - {Z}_{α / 2} * \frac{{s}_{{\hat{t}}_{5}}}{\sqrt{J}} , \overline{\hat{t}} + {Z}_{α / 2} * \frac{{s}_{{\hat{t}}_{5}}}{\sqrt{J}} ) .$$

11. The predictor of the period of psychotic episode in individual schizophrenia patients of claim 7, wherein said step(h) at least comprises the following steps:
(h1) observe patient's steady state or relapse whether its occurrence is fall in said confidence interval; if yes, then said confidence interval be regarded as a successful prediction;
(h2) incorporate this t5 value of steady state time point into historical data, repeat said data construct for calculate new fΔI and fΔT in order to predict emersion time of next steady state time point i6.

12. A method to predict relapse time of schizophrenia patients, it is characterised by make use of historical time points of total incidents of patients' recurrence and steady state to find its regularity, and estimate time point of next relapse or steady state.
